(19) United States
(12) Patent Application Publication
(10) Pub. No.: US 2017/0166007 A1
(43) Pub. Date: Jun. 15, 2017

(54) TWO-PIECE AXLE SHAFT

(71) Applicant: FORD GLOBAL TECHNOLOGIES, LLC, Dearborn, MI (US)

(72) Inventors: Brian James ANDONIAN, Plymouth, MI (US); Thomas GURNE, Royal Oak, MI (US)

(21) Appl. No.: 14/964,644

(22) Filed: Dec. 10, 2015

(51) Int. Cl. B60B 35/12; B60B 27/06; F16C 3/02

(52) U.S. Cl. CPC B60B 35/12; F16C 3/02; B60B 27/065

(57) ABSTRACT

Two-piece axle shafts are disclosed. The shafts may include an outer ring including an outer portion and an inner portion recessed in the outer portion and having a first passage defined therein and an axle shaft including a bar and a flanged end having a second passage defined therein and forming a press fit with the outer ring. A fastener may extend within the first and second passages. The flanged end may have an outer perimeter that forms a press fit with a wall extending between the inner portion and the outer portion of the outer ring. The fasteners may be press-fit fasteners or threaded fasteners. In one embodiment, there may be a plurality of apertures in the inner portion and the flanged end and fasteners may extend through both apertures and secure to a wheel hub. The two-piece axle shaft may reduce transverse grain flow.

### TECHNICAL FIELD

The present disclosure relates to axle shafts, for example, two-piece axle shafts.

### BACKGROUND

Wheeled vehicles generally include at least one axle shaft. In general, axle shafts transmit driving torque to the wheel. In some systems, such as semi-float systems, the axle shaft may also support the weight of the vehicle. In other systems, such as full-float systems, the axle shaft may substantially only transmit torque to the wheel, but not support any vertical load of the vehicle. Axle shafts designs may vary for cars or light, middle, or heavy-duty trucks. However, in general, axle shafts may have a flange at one end. The flanged end may be formed by forging, for example, upset forging, wherein the end of a workpiece is compressed, or upset, to increase the diameter at that end. The ratio of the flange diameter to the diameter of the axle shaft may correspond to the amount or degree of upsetting, with a higher ratio indicating greater upset.

### SUMMARY

In at least one embodiment, a two-piece axle shaft is provided. The two-piece axle shaft may include an outer ring including an outer portion and an inner portion recessed in the outer portion and having a first passage defined therein. An axle shaft including a bar and a flanged end having a second passage defined therein may form a press fit with the outer ring. A fastener may extend within the first and second passages.

The inner portion may have a contact surface defined therein configured to contact the flanged end and a wall may extend from the contact surface to an outer surface of the outer portion. The flanged end may include an outer perimeter that forms the press fit with the wall. In one embodiment, the wall is perpendicular to the contact surface and the outer surface of the outer portion. The fastener may be a press-fit fastener, a screw, or a bolt. In one embodiment, at least one of the first and second passages is a blind bore.

The inner portion may include a plurality of apertures defined therein separate from the first passage and the flanged end may include a plurality of apertures defined therein separate from the second passage. The inner portion may have a plurality of passages defined therein and the flanged end may have a plurality of passages defined therein and the two-piece axle shaft may include a plurality of fasteners, each fastener extending within a passage in the inner portion and a passage in the flanged end.

In at least one embodiment, a two-piece axle shaft is provided. The two-piece axle shaft may include an outer ring including an outer portion and an inner portion recessed in the outer portion and having a plurality of openings defined therein. It may further include an axle shaft including a bar and a flanged end having a plurality of apertures defined therein and contacting the inner portion. There may be a plurality of fasteners, each fastener extending within an opening and an aperture.

In one embodiment, the openings and apertures are through-bores and the plurality of fasteners each extend completely through the openings and apertures. At least one of the plurality of fasteners may include a threaded portion and the threaded portion may not engage with the openings or apertures. In one embodiment, the threaded portion engages with a wheel hub. The outer portion of the outer ring may include a plurality of openings defined therein. A plurality of wheel mounting studs may extend through the plurality of openings in the outer portion. In one embodiment, the inner portion further includes a first passage defined therein separate from the plurality of openings, the flanged end includes a second passage defined therein separate from the plurality of apertures, and a fastener extends within the first and second passages. The flanged end may include an outer perimeter that forms a press fit with a wall extending between the inner portion and the outer portion of the outer ring.

In at least one embodiment, an axle shaft assembly is provided. The assembly may include a two-piece axle shaft including an outer ring having an outer portion and an inner portion recessed in the outer portion and having one or more openings defined therein; and an axle shaft including a flanged end having one or more apertures defined therein. The assembly may also include a wheel hub and one or more fasteners, each fastener extending through an opening and an aperture and secured to the wheel hub.

The axle shaft assembly may be a full-float or semi-float axle shaft assembly. In one embodiment, the inner portion further includes a first passage defined therein separate from the one or more openings, the flanged end includes a second passage defined therein separate from the one or more apertures, and a fastener extends within the first and second passages.

### BRIEF DESCRIPTION OF THE DRAWINGS

FIG. 1 is an exploded view of a two-piece axle shaft, according to an embodiment;

FIG. 2 is a perspective view of the assembled two-piece axle shaft of FIG. 1;

FIG. 3 is a cross-section of a two-piece axle shaft showing apertures in the flanged end and the outer ring, according to an embodiment;

FIG. 4 is another cross-section of a two-piece axle shaft showing a different set of apertures in the flanged end and the outer ring with fasteners inserted therein, according to an embodiment;

FIG. 5 is a perspective view of an axle shaft assembly including a two-piece axle shaft connected to a wheel hub via fasteners extending through apertures in the flanged end and the outer ring, according to an embodiment; and

FIG. 6 is a partial cutaway of an axle shaft assembly including a two-piece axle shaft connected to a wheel hub via fasteners extending through apertures in the flanged end and the outer ring, according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As described in the Background, axle shafts may be forged to form a flange at one end. For example, the flange may be formed by upset forging wherein a punch applies an axial force to one end of the axle shaft in cooperation with a die. The larger the desired flange diameter, the greater upset required. In general, there may be a limit for a given upset forging process on the maximum ratio of final forged flange volume to the original bar or shaft diameter. When the ratio exceeds the limit, certain problems may occur. One problem may be transverse forging grain flow. The grain flow of a metal forging is the directional orientation of the metal grains in the component. Grain flow or orientation does not affect all mechanical properties. For example, the strength and/or hardness of an alloy are not significantly affected by grain flow. However, some properties associated with retarding crack propagation may be impacted, depending on the grain flow and the direction of a propagating crack. Properties such as fatigue strength, impact toughness, and ductility may be affected by grain flow. These properties may be improved if the crack propagation direction and the grain flow are properly aligned. For example, when the maximum principal stress (e.g., perpendicular to a potential crack) is aligned with the grain flow direction, the tendency for crack propagation is reduced.

In general, the grain flow of an axle shaft is parallel or near-parallel to the longitudinal axis of the shaft. However, during the upset forging process, wherein one end may be compressed or upset to form a flange, the grain flow may be changed or altered in the flange and in the bar adjacent to the flange. The grain flow in the flange itself may be transverse, or perpendicular to the longitudinal axis of the bar. This is not typically a problem if the transverse grain flow is in the flange region of the shaft where the shear stress due to torsion is low, relative to the bar region. But, if the end of the bar, near or adjacent to the flange, develops transverse grain flow, the impact strength and/or fatigue strength may be compromised because the grain flow is oriented such crack propagation is not retarded.

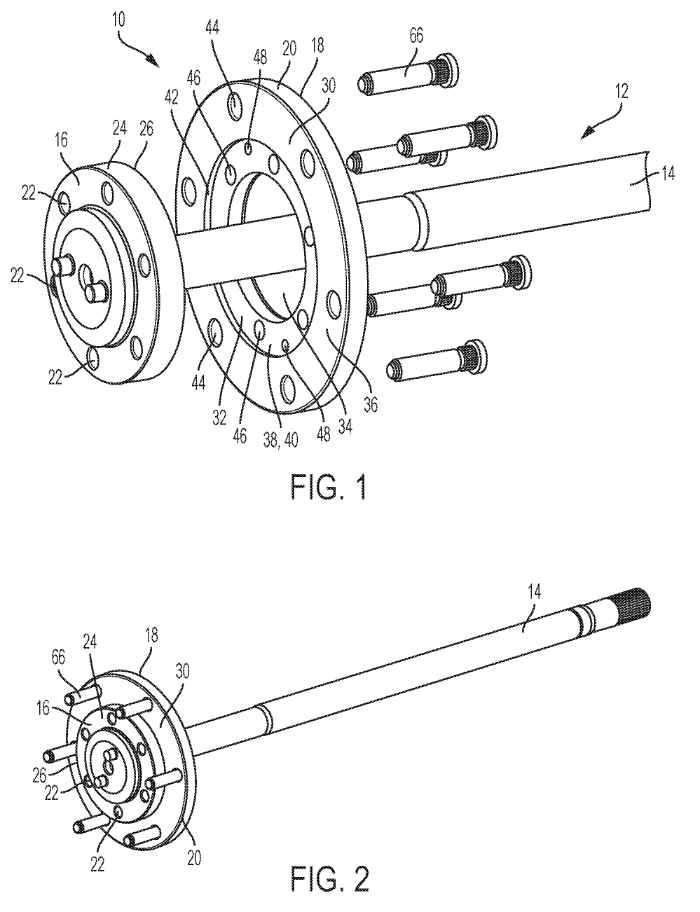

With reference to FIGS. 1-4, a two-piece axle shaft 10 is disclosed that may have reduced transverse grain flow, thereby improving properties such as fatigue and/or impact strength. The two-piece axle shaft 10 may include an axle shaft 12 including a bar 14 and a flanged end 16. The flanged end 16 may be formed using any suitable method, such as upset forging. Attached or secured to the flanged end 16 may be an outer ring 18. Accordingly, the two-piece axle shaft may be formed from two separate pieces—the axles shaft 12 and the outer ring 18. As used herein, “two-piece” may be defined as non-permanently attached, such that the two pieces (the axle shaft 12 and the outer ring 18) may be detached without cutting, breaking, or otherwise physically altering either piece. For example, “two-piece” would not include the axle shaft 12 and the outer ring being welded together.

By attaching an outer ring 18 to the relatively small flanged end 16, a large flange 20 may be formed at the end of the axle shaft 12. However, because the amount of upset required to form the diameter of the flanged end 16 is relatively small compared to upset forging a diameter of flange 20, there is a reduced risk of forming transverse grain flow in the bar 14 near or adjacent to the flanged end 16. Accordingly, a large flange diameter can be formed without the increased probability of reduced fatigue and/or impact strength.

The flanged end 16 may have a circular end profile. The flanged end 16 may have one or more (e.g., a plurality) of openings or apertures 22 formed therein. The apertures 22 may be radially spaced around the flanged end 16, for example, around the circumference of the flanged end 16, as shown. The apertures 22 may be evenly spaced. In one embodiment, there may be 2, 3, 4, 5, 6, or more apertures 22. The apertures 22 may be through bores, such that they extend through the full thickness of the flanged end 16. The flanged end 16 may include an inner ring 24 that extends back towards and encircles the bar 14. The apertures 22 may be located in the inner ring 24. The inner ring 24 may have an outer perimeter 26, which may be circular in shape. The inner ring 24 may be annular in shape and include an opening 28 therein through which the bar 14 extends.

The outer ring 18 may include an outer portion 30 and an inner portion 32. Both the outer and inner portions may be annular or ring-like in shape. The inner portion 32 may have a central opening 34 defined therein, which may be circular and may be sized to allow the outer ring 18 to pass over the bar 14. The inner portion 32 may be recessed or countersunk into the outer portion 30. The outer portion 30 may include an outer surface 36 and the inner portion 32 may include an outer surface 38, which may be a contact surface 40 configured to contact the inner ring 24 of the flanged end 16. The outer surface 36 and the contact surface 40 may be parallel and spaced apart. A wall 42 may extend between the outer surface 36 and the contact surface 40, and may be perpendicular to both.

The inner portion 32 may be recessed or countersunk by any suitable amount. In one embodiment, the inner portion may be recessed from 0.5 to 10 mm into the outer portion 30, or any sub-range therein, such as 1 to 5 mm, 2 to 4 mm, or about 3 mm (e.g., ±0.5 mm). Accordingly, the wall 42 may have a height that is the same as the recessed distance. In addition to facilitating a press/interference fit with the flanged end 16 (described in greater detail, below), the recessed inner portion 32 may provide a locating and/or centering function when attaching or connecting the two pieces of the two-piece axle shaft 10. This may ensure that the axle shaft 12 and the outer ring 18 are coaxial and/or that the inner ring 24 and the outer ring 18 are concentric.

The outer portion 30 of the outer ring 18 may include one or more (e.g., a plurality) apertures 44. The apertures 44 may be spaced around a circumference of the outer portion 30. The apertures 44 may be evenly spaced. In one embodiment, there may be 2, 3, 4, 5, 6, or more apertures 44. The apertures 44 may be through bores, such that they extend through the full thickness of the outer portion 30. The inner portion 32 may include one or more (e.g., a plurality) apertures 46. The apertures 46 may be spaced around a circumference of the inner portion 32. The apertures 46 may be evenly spaced. In one embodiment, there may be 2, 3, 4, 5, 6, or more apertures 46. The apertures 46 may be through bores, such that they extend through the full thickness of the inner portion 32.

In one embodiment, the apertures 22 in the flanged end 16 and the aperture 46 in the inner portion 32 of the outer ring 18 may be configured to be aligned and coaxial. There may be an equal number of apertures 22 and apertures 46, which may also have the same or similar diameters. Accordingly, each pair of apertures 22 and 46 may be configured to receive a fastener therethrough. For example, if there are six apertures 22 and six apertures 46, as shown in FIG. 1, then six fasteners may be inserted with each fastener passing through one aperture 22 and one aperture 46.

The inner portion 32 may include one or more (e.g., a plurality) passages 48 separate from the apertures 46. The passages 48 may be spaced around a circumference of the inner portion 32. The passages 48 may be evenly spaced. In one embodiment, there may be 2, 3, 4, 5, 6, or more passages 48. The passages 48 may be through bores, such that they extend through the full thickness of the inner portion 32, or they may be blind bores, such that they only extend partially through the thickness of the inner portion 32. If the passages 48 are blind bores, they may extend through the contact surface 40 of the inner portion 32. In one embodiment, the passages 48 may be spaced between the apertures 46. In another embodiment, the passages 48 may be disposed closer to an outer perimeter of the inner portion 32 than an inner perimeter (e.g., as shown in FIG. 1).

With reference to FIG. 4, the flanged end 16 may include one or more (e.g., a plurality) passages 50 separate from the apertures 22. The passages 50 may be spaced around a circumference of the inner ring 24. The passages 50 may be evenly spaced. In one embodiment, there may be 2, 3, 4, 5, 6, or more passages 50. The passages 50 may be through bores, such that they extend through the full thickness of the inner ring 24, or they may be blind bores, such that they only extend partially through the thickness of the inner ring 24. If the passages 50 are blind bores, they may extend through a rear surface 52 of the inner ring 24. The rear surface 52 may be the surface configured to face the contact surface 40 of the inner portion 32. In one embodiment, the passages 50 may be spaced between the apertures 22. In another embodiment, the passages 50 may be disposed closer to an outer perimeter of the inner ring 24 than an inner perimeter (e.g., as shown in FIG. 4).

In one embodiment, the passages 48 in the inner portion 32 and the passages 50 in the inner ring 24 of the flanged end 16 may be configured to be aligned and coaxial. There may be an equal number of passages 48 and passages 50, which may also have the same or similar diameters. Accordingly, each pair of passages 48 and 50 may be configured to receive a fastener. For example, if there are two passages 48 and two passages 50, as shown in FIGS. 1 and 4, then two fasteners may be inserted with each fastener extending within one passage 48 and one passage 50. The term fastener may include any mechanical fastener known in the mechanical arts, such as screws, bolts, dowels, rivets, or others.

In FIG. 4, two fasteners 54 are shown, one each in a pair of passages 48 and 50. The fasteners 54 are shown as dowels, which are configured to create a press or interference fit to join, connect, or secure the flanged end 16 and the outer ring 18. The dowels may have a diameter that is the same or slightly larger than the passages 48 and 50 in order to create an interference fit when the dowel is inserted into the passages. In FIG. 4, the passages 50 in the inner ring 24 are shown as blind bores and the passages 48 in the inner portion 32 of the outer ring 18 are shown as through bores. Accordingly, the fasteners 54 may be inserted through the passages 48 from an inner surface 56 of the inner portion 32. The dowels may extend partially in the passages 48 and partially in the passages 50, thereby forming a press or interference fit to join or secure the flanged end 16 and the outer ring 18. Any suitable type or shape of dowel may be used. For example, the dowels may be metal, such as iron, steel, aluminum, titanium, alloys thereof, or other suitable metals. The dowels may be cylindrical, solid, hollow, or grooved. The dowels may also be spirals, springs, or coils, which may provide torsional resistance.

While the fasteners 54 are shown as dowels, other fastener types may be used to join or secure the flanged end 16 and the outer ring 18. For example, the fasteners 53 may be threaded screws or bolts. In order to secure the two components, one or both of the passages 48 and 50 may be at least partially threaded. In the example shown in FIG. 4, the blind passages 50 may be at least partially threaded such that a screw or bolt may be inserted from the from inner surface 56 of the inner portion 32, similar to the dowel. The screw or bolt may then be threaded into the threaded portion of the passage 50 in the inner ring 24. However, other configurations may also be used. For example, the passage 48 may be a blind bore and the passage 48 may be a through bore and the fastener 54 may be introduced from a front surface 58 of the inner ring 24. In this embodiment, the passage 48 may be at least partially threaded. In another embodiment, both passages 48 and 50 may be through bores and either or both may be at least partially threaded. A screw or bolt could then be threaded in from either side. Alternatively, a rivet may be inserted through one end of the through bores and upset or deformed on the other end. In another embodiment, both passages 48 and 50 may be blind bores and a dowel may be inserted in one passage and then pressed into the other passage.

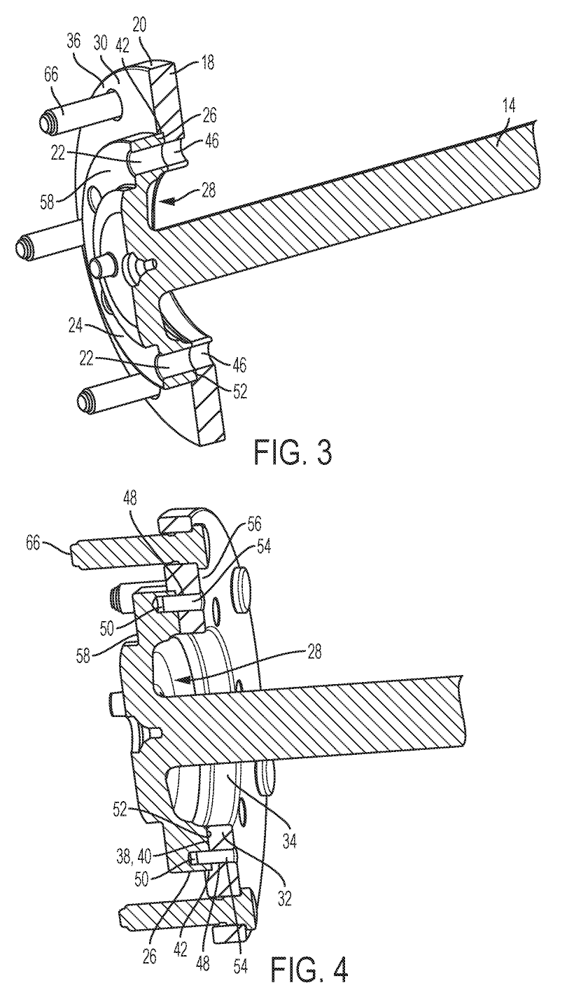

In addition to the fastener(s) 54 joining or securing the flanged end 16 to the outer ring 18, there may also be a press or interference fit between the inner ring 24 of the flanged end 16 and the inner portion 32 of the outer ring 18. For example, the outer perimeter 26 of the inner ring 24 may be sized and configured to form a press or interference fit with the wall 42 of the outer ring 18 and/or the contact surface 40 of the inner portion 32 of the outer ring 18. Examples of this press or interference fit are shown in FIGS. 3 and 4. Accordingly, the flanged end 16 and the outer ring 18 may be joined or secured to each other in one or more ways. Fasteners 54 may join/secure the two parts, for example, through a threaded screw/bolt, a press fit dowel, or a rivet. In addition, or instead of the fasteners 54, a press/interference fit may be formed between the inner ring 24 of the flanged end 16 and the inner portion 32 of the outer ring 18. These mechanism(s) of joining or securing the flanged end 16 and the outer ring 18 may be the only means of connection between the two parts, or there may be additional connection mechanisms.

In at least one embodiment, the flanged end 16 and the outer ring 18 may also, or alternatively, be joined or secured using fasteners 60. Fasteners 60 may be configured to extend through the apertures 22 in the flanged end 16 (e.g., in the inner ring 24) and through the apertures 46 in the outer ring 18 (e.g., in the inner portion 32). As described above, the apertures 22 in the flanged end 16 and the aperture 46 in the inner portion 32 of the outer ring 18 may be configured to be aligned and coaxial. Accordingly, each fastener 60 may extend through a pair of the apertures 22 and apertures 46.

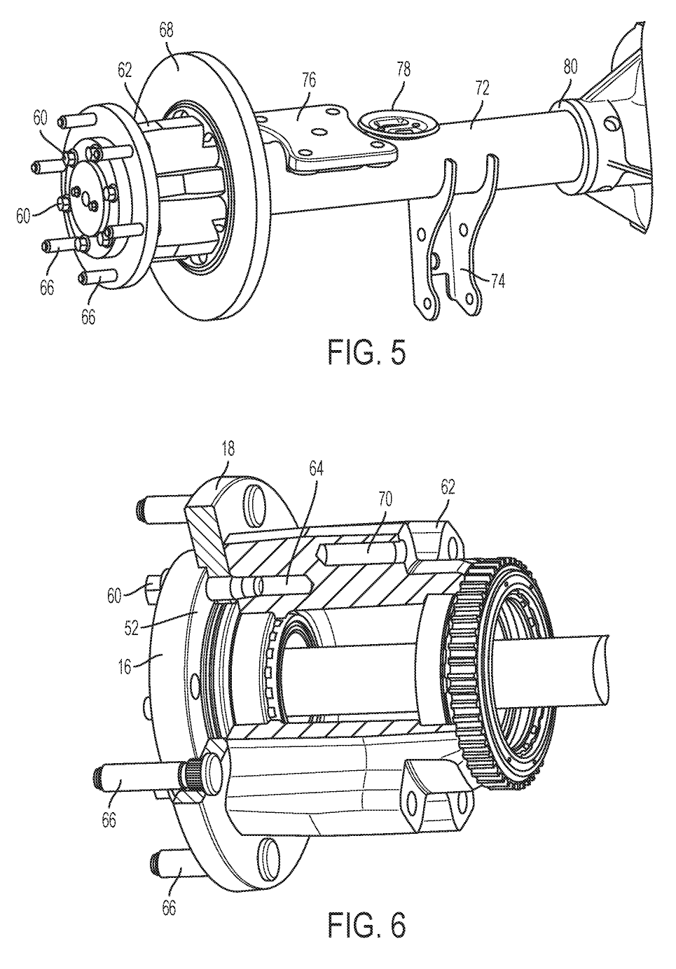

In one embodiment, the fasteners 60 may also serve an additional function, in addition to joining or securing the flanged end 16 and the outer ring 18. For example, the fasteners 60 may be axle shaft mounting bolts. The axle shaft mounting bolts may secure the axle shaft 12 to a wheel hub 62, as shown in FIGS. 5 and 6. The wheel hub 62 may include passages 64, which may be at least partially threaded to couple with a threaded portion of a fastener 60. The passages 64 may be configured to be aligned and coaxial with the apertures 22 in the flanged end 16 and the apertures 46 in the inner portion 32 of the outer ring 18. There may also be the same number of passages 64 as the apertures 22 and/or 46. Each fastener 60 may therefore extend through an aperture 22 and an aperture 46 and at least partially into a passage 64 in a wheel hub 62.

The fasteners 60 may have a threaded portion that engages a threaded portion of the passage 64. The apertures 22 and 46 may therefore be unthreaded and the flanged end 16 and the outer ring 18 may be held together in the axial direction (e.g., direction parallel to the apertures/passages) by the clamping force of the fasteners 60 coupling to the threaded portion of the passages 64. For example, the clamping force may be provided by the head of the fasteners 60 on one end and the engaged threaded portions on the other end. However, one or both of the apertures 22 and apertures 46 may be at least partially threaded such that the fasteners 60 may also engage them directly. The fasteners 60 may also prevent relative rotation between the flanged end 16 and the outer ring 18 by extending through the apertures 22 and 46. While the fasteners 60 are shown as axle shaft mounting bolts that engage a wheel hub 62, the fasteners 60 may engage other components (either in addition to, or instead of, the wheel hub). For example, the fasteners 60 may engage the wheel rotors (e.g., via clearance holes in the hub). In this example, the wheel rotor may be inboard of the hub.

In one embodiment, the apertures 44 in the outer portion 30 of the outer ring 18 may be configured to receive fasteners 66. The fasteners 66 may be wheel mounting studs, which may be configured to engage a wheel of the vehicle. The fasteners 66 may include a threaded portion, which may be configured to engage with a lug nut or wheel nut (not shown) to secure the wheel to the two-piece axle shaft 10. While the fasteners 66 are shown as wheel mounting studs, the fasteners 66 may engage other components (either in addition to, or instead of, a lug nut or wheel nut).

As shown in FIG. 5, the fasteners 60 may engage a wheel hub 62. On an opposite side of the wheel hub 62 from the flange 20 (formed from the flanged end 16 and the outer ring 18) may be a brake rotor 68. The wheel hub 62 may include passages 70 configured to receive fasteners that extend through the brake rotor 68 and engage with the passages 70 (e.g., through a threaded connection in the passages 70). Other components shown that may be included in the axle shaft assembly are an axle tube 72, a shock bracket 74, a leaf spring seat 76, a jounce bumper bracket 78, and a carrier tube trunnion 80. However, one of ordinary skill in the art will understand that certain components may be omitted, altered, or substituted for other components.

The disclosed two-piece axle shaft 10 may be used in any type of axle system, such as a full float axle system or a semi-float axle system. The two-piece axle shaft 10 is shown in FIGS. 5 and 6 as part of a full float axle system, however, one of ordinary skill in the art will be able to adapt and incorporate the two-piece axle shaft 10 into other systems based on the current disclosure. The two-piece axle shaft 10 may be used in any type of wheeled vehicle, such as cars, vans, trailers, or trucks. For example, if used in a truck, the truck may be a light, medium, or heavy-duty truck. The disclosed two-piece axle shaft 10 may be used as a front and/or rear axle shaft, depending on the vehicle. The disclosed two-piece axle shaft 10 may also be used in double wheel and/or double axle systems.

The axle shaft 12 and the outer ring 18 of the two-piece axle shaft 10 may be formed of the same material or alloy, such as steel or iron (e.g., ductile iron). However, the two pieces do not have to be formed of the same material or alloy. In one embodiment, the outer ring 18 may be formed of a material or alloy having a lower strength (e.g., yield or tensile strength) than the axle shaft 12. The outer ring 18 may see less stress (e.g., shear stress) than the axle shaft 12 during operation, and therefore may not need to be as strong. Accordingly, the outer ring 18 may be formed of a material/alloy that is not as strong, not heat treated, or that is not heat treatable, but that may be more cost effective, easier to form, or have other properties that may be preferred to the material/alloy of the axle shaft 12. For example, the outer ring 18 may be formed of a ductile iron and/or may be cast. Castings are typically less expensive than forgings, therefore, in addition to reducing transverse grain flow, the two-piece axle shaft may result in cost savings.

The axle shaft 12 (e.g., the bar 14 and flanged end 16) may be formed using any suitable process. In one embodiment, the axle shaft may be formed by upset forging, such as conventional mechanical upset forging or electric upsetting. However, over types of forging or other forming processes may also be used. The outer ring 18 may also be formed by any suitable process. While the outer ring 18 may be forged, in at least one embodiment, it may be formed by a process other than forging. Since the outer ring 18 is a separate piece from the axle shaft 12, it may be formed using more energy/cost effective or more efficient processes. For example, the outer ring 18 may be formed by casting, stamping, machining (e.g., cutting, milling, etc.), or other forming processes.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A two-piece axle shaft comprising:
an outer ring including an outer portion and an inner portion recessed in the outer portion and having a first passage defined therein;
an axle shaft including a bar and a flanged end having a second passage defined therein and forming a press fit with the outer ring; and
a fastener extending within the first and second passages.

2. The shaft of claim 1, wherein the inner portion has a contact surface defined therein configured to contact the flanged end and a wall extends from the contact surface to an outer surface of the outer portion.

3. The shaft of claim 2, wherein the flanged end includes an outer perimeter that forms the press fit with the wall.

4. The shaft of claim 2, wherein the wall is perpendicular to the contact surface and the outer surface of the outer portion.

5. The shaft of claim 1, wherein the fastener is a press-fit fastener.

6. The shaft of claim 1, wherein the fastener is a screw or bolt.

7. The shaft of claim 1, wherein at least one of the first and second passages is a blind bore.

8. The shaft of claim 1, wherein the inner portion includes a plurality of apertures defined therein separate from the first passage and the flanged end includes a plurality of apertures defined therein separate from the second passage.

9. The shaft of claim 1, wherein the inner portion has a plurality of passages defined therein and the flanged end has a plurality of passages defined therein and the two-piece axle shaft includes a plurality of fasteners, each fastener extending within a passage in the inner portion and a passage in the flanged end.

10. A two-piece axle shaft comprising:
an outer ring including an outer portion and an inner portion recessed in the outer portion and having a plurality of openings defined therein;
an axle shaft including a bar and a flanged end having a plurality of apertures defined therein and contacting the inner portion; and
a plurality of fasteners, each fastener extending within an opening and an aperture.

11. The shaft of claim 10, wherein the openings and apertures are through-bores and the plurality of fasteners each extend completely through the openings and apertures.

12. The shaft of claim 11, wherein at least one of the plurality of fasteners includes a threaded portion and the threaded portion does not engage with the openings or apertures.

13. The shaft of claim 12, wherein the threaded portion engages with a wheel hub.

14. The shaft of claim 10, wherein the outer portion of the outer ring includes a plurality of openings defined therein.

15. The shaft of claim 14 further comprising a plurality of wheel mounting studs extending through the plurality of openings in the outer portion.

16. The shaft of claim 10, wherein the inner portion further includes a first passage defined therein separate from the plurality of openings; the flanged end includes a second passage defined therein separate from the plurality of apertures; and a fastener extends within the first and second passages.

17. The shaft of claim 10, wherein the flanged end includes an outer perimeter that forms a press fit with a wall extending between the inner portion and the outer portion of the outer ring.

18. An axle shaft assembly, comprising:
a two-piece axle shaft including:
an outer ring having an outer portion and an inner portion recessed in the outer portion and having one or more openings defined therein; and
an axle shaft including a flanged end having one or more apertures defined therein;
a wheel hub; and
one or more fasteners, each extending through an opening and an aperture and secured to the wheel hub.

19. The assembly of claim 18, wherein the axle shaft assembly is a full-float axle shaft assembly.

20. The assembly of claim 18, wherein the inner portion further includes a first passage defined therein separate from the one or more openings; the flanged end includes a second passage defined therein separate from the one or more apertures; and a fastener extends within the first and second passages.
